(19) United States
(12) Patent Application Publication
(10) Pub. No.: US 2016/0241589 A1
(43) Pub. Date: Aug. 18, 2016

(54) METHOD AND APPARATUS FOR IDENTIFYING MALICIOUS WEBSITE

(71) Applicant: Tencent Technology (Shenzhen) Company Limited, Shenzhen (CN)

(72) Inventor: Jian LIU, Shenzhen (CN)

(21) Appl. No.: 15/136,771

(22) Filed: Apr. 22, 2016

Related U.S. Application Data
(63) Continuation of application No. PCT/CN2014/088251, filed on Oct. 10, 2014.

(30) Foreign Application Priority Data
Oct. 23, 2013 (CN) 201310503579.9

(51) Int. Cl. H04L 29/06

(52) U.S. Cl. CPC H04L 63/1441

(57) ABSTRACT

Disclosed are a method and an apparatus for identifying a malicious website, the method including: acquiring uniform resource locators (URLs) of websites determined as malicious websites and URLs of websites determined as safe websites; performing feature extraction on the URLs of the malicious websites to obtain a first feature character set and performing feature extraction on the URLs of the safe websites to obtain a second feature character set; and determining whether a frequency of a first feature character obtained by feature extraction in the first feature character set is higher than a frequency in the second feature character set, and if the frequency of the first feature character in the first feature character set is higher than the frequency in the second feature character set, adding the first feature character into a malicious feature library, feature characters in the malicious feature library being used for identifying a malicious website.

### RELATED APPLICATIONS

This application is a continuation application of PCT Patent Application No. PCT/CN2014/088251, entitled “METHOD AND APPARATUS FOR IDENTIFYING MALICIOUS WEBSITE” filed on Oct. 10, 2014, which claims priority to Chinese Patent Application No. 201310503579.9, entitled “METHOD AND APPARATUS FOR IDENTIFYING MALICIOUS WEBSITE” filed on Oct. 23, 2013, both of which are incorporated by reference in their entirety.

### FIELD OF THE TECHNOLOGY

The present disclosure relates to the field of communications technologies, and in particular, to a method and an apparatus for identifying a malicious website.

### BACKGROUND OF THE DISCLOSURE

Fast development of Internet technologies brings more convenience to life of people. People can conveniently share and download all sorts of data, acquire all sorts of important information, pay bills online, and the like by using the Internet. However, the security situation of the Internet is not optimistic; different Trojan viruses are disguised as normal files and are recklessly spread, and the situation in which phishing websites imitate normal websites steal user accounts and passwords becomes worse.

There are usually two schemes for identifying and cracking down malicious websites in the industry. One scheme is a method based on user reporting and manual audit. For example, a user may submit a uniform resource locator (URL) of a suspicious website; after the website is manually verified to be malicious, the URL of the website is added into a malicious URL list, and in this way, in a subsequent malicious website identification process, the malicious URL list is used to determine a malicious website. First, the audit quality of manual audit depends on expertise of auditors. Besides, because the number of auditors is limited, long time is needed from the time when the URL is submitted and to the time when the website is determined to be malicious, and it cannot be ensured that the URL is authenticated in time and effectively.

The other scheme is a method based on webpage feature identification. For example, it is authenticated whether a page includes features such as a suspicious keyword. In the method, a security software developer is required to analyze a great number of samples of malicious URLs, extract key malicious page features, and add a corresponding feature judgment logic in an authentication program. From being spread on a small scale to being finally released, it generally takes weeks or months for a website using a particular malicious feature. Therefore, it often takes a long period to find the malicious feature after the malicious feature appears.

### SUMMARY

Embodiments of the present disclosure provide a method and an apparatus for identifying a malicious website, which are used to solve the foregoing problems.

A method for identifying a malicious website includes:

acquiring uniform resource locators (URLs) of websites determined as malicious websites and URLs of websites determined as safe websites;

performing feature extraction on the URLs of the malicious websites to obtain a first feature character set, and performing feature extraction on the URLs of the safe websites to obtain a second feature character set; and

determining whether a frequency of a first feature character obtained by feature extraction in the first feature character set is higher than a frequency in the second feature character set, and if the frequency of the first feature character in the first feature character set is higher than the frequency in the second feature character set, adding the first feature character into a malicious feature library, feature characters in the malicious feature library being used for identifying a malicious website.

An apparatus for identifying a malicious website includes:

a sample acquisition unit, configured to acquire uniform resource locators (URLs) websites determined as malicious websites and EJRLs of websites determined as safe websites;

a feature extraction unit, configured to perform feature extraction on the URLs, acquired by the sample acquisition unit, of the malicious websites to obtain a first feature character set and perform feature character extraction on the URLs of the safe websites to obtain a second feature character set; and

a feature judgment unit, configured to determine whether a frequency of a first feature character obtained by feature extraction in the first feature character set is higher than a frequency in the second feature character set, and if the frequency of the first feature character in the first feature character set is higher than the frequency in the second feature character set, and a frequency of the first feature character set obtained by the feature extraction unit by feature extraction is higher than a frequency in the second feature character set, add the first feature character into a malicious feature library, feature characters in the malicious feature library being used for identifying a malicious website.

A non-instantaneous computer readable storage medium stores computer executable instructions thereon, and when these executable instructions are run in a computer, executes the following steps:

acquiring uniform resource locators (URLs) of websites determined as malicious websites and URLs of websites determined as safe websites;

performing feature extraction on the URLs of the malicious websites to obtain a first feature character set, and performing feature character extraction on the URLs of the safe websites to obtain a second feature character set; and

determining whether a frequency of a first feature character obtained by feature extraction in the first feature character set is higher than a frequency in the second feature character set, and if the frequency of the first feature character in the first feature character set is higher than the frequency in the second feature character set, adding the first feature character into a malicious feature library, feature characters in the malicious feature library being used for identifying a malicious website.

It can be seen from the foregoing technical solutions that in the embodiments of the present disclosure, feature character extraction is performed based on a URL, specific feature characters are determined from extracted feature characters and are added into a malicious feature library so as to identify a malicious website. By means of a comparison method, new malicious features in the URLs are extracted and added into the malicious feature library, so as to shorten a period to find the new malicious feature after the malicious feature appears.

### BRIEF DESCRIPTION OF THE DRAWINGS

FIG. 1 is a schematic flowchart of a method according to an embodiment of the present disclosure;

FIG. 2 is a schematic flowchart of a method according to an embodiment of the present disclosure;

FIG. 3 is a schematic flowchart of a method according to an embodiment of the present disclosure;

FIG. 4 is a schematic structural diagram of a system according to an embodiment of the present disclosure;

FIG. 5 is a schematic structural diagram of an identification apparatus according to an embodiment of the present disclosure;

FIG. 6 is a schematic structural diagram of an identification apparatus according to an embodiment of the present disclosure;

FIG. 7 is a schematic structural diagram of an identification apparatus according to an embodiment of the present disclosure; and

FIG. 8 is a schematic diagram of a terminal and server system according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

When URLs detected to be malicious are analyzed, it is found that many malicious URLs all contain similar content fragments. This is because when finding one type of website bugs, hackers will upload similar files in batches to similar categories for a website containing this type of bugs and generate a URL address having a similar path or a file name. For example, after vulnerability of a website constructing tool DedeCms was exposed, hackers utilized the vulnerability to attack a large quantity of sites and uploaded 90 sec.php files under the plus category, and malicious URLs similar to the following ones were spread on the Internet. As shown in Table 1:

TABLE 1
examples of malicious URLs

| Sequential No. | Examples of URLs |
|---|---|
| 1 | http://ixyy.web-103.com/plus/90sec.php |
| 2 | http://www.meiruoji.com/plus/90sec.php |
| 3 | http://www.hnhmjx.com/plus/90sec.php |
| 4 | http://www.33283328.com/plus/90sec.php |
| 5 | http://www.csenchi.com/plus/90sec.php |
| 6 | http://www.mlwhj.com/plus/90sec.php |
| . . . | ********************/plus/90sec.php |
| n | http://www.mvbocai.com/plus/90sec.php |

Feature analysis is performed on URLs of websites verified as malicious websites within a period; a distinguishing feature (for example, 90 sec in the foregoing example) can be automatically detected and is added into a malicious feature library; then an unknown URL may be first matched in the malicious feature library, and may be considered to be malicious if matching succeeds.

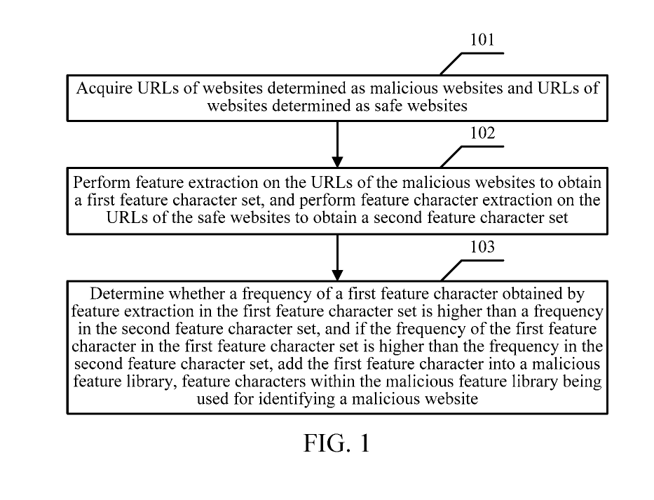

An embodiment of the present disclosure provides a method for identifying a malicious website, which may be implemented in a cloud security server or another server at a network side. As shown in FIG. 1, FIG. 1 includes step 101 to step 103.

Step 101: Acquire URLs of websites determined as malicious websites and URLs of websites determined as safe websites.

In this embodiment, to ensure real-time identification, the URLs of the malicious websites in this step may be URLs of malicious websites that are verified within a period before current time; and the URLs of the safe websites in this step may be URLs of safe websites that are verified within a period before current time.

In addition, a quantity of acquired URLs of each domain name is limited within a predetermined quantity; in this way, the problem that domain names are centralized is alleviated.

A background cloud server such as a computer management tool often saves security information of a great quantity of URLs. Therefore, URLs relevant to this step may be obtained from a database of a security server or may be acquired in other manners, which is not limited in this embodiment.

Step 102: Perform feature extraction on the URLs of the malicious websites to obtain a first feature character set, and perform feature character extraction on the URLs of the safe websites to obtain a second feature character set.

In this embodiment, feature extraction may be performed by using a non-number and non-English letter as partition.

It should be noted that feature extraction may be performed in multiple manners; an example in this embodiment is only a preferable example applicable to URL feature extraction and applicable to malicious website identification; an algorithm for changing feature extraction does not influence implementation of this embodiment of the present disclosure; a person skilled in the art may perform algorithm selection according to actual situations. Therefore, this embodiment of the present disclosure does not limit an algorithm used by feature extraction. The foregoing example of performing feature extraction by using a non-number and non-English letter as partition should not be understood as unique limitation to this embodiment of the present disclosure.

Step 103: Determine whether a frequency of a first feature character obtained by feature extraction in the first feature character set is higher than a frequency in the second feature character set, and if the frequency of the first feature character in the first feature character set is higher than the frequency in the second feature character set, add the first feature character into a malicious feature library, feature characters in the malicious feature library being used for identifying a malicious website.

In the forgoing embodiment of the present disclosure, feature character extraction is performed based on a URL, specific feature characters are determined from extracted feature characters and are added into a malicious feature library so as to identify a malicious website. In this embodiment, by means of a comparison method, new malicious features in the URL are extracted and added into the malicious feature library, so as to shorten a period to find the new malicious feature after the malicious feature appears.

Optionally, this embodiment of the present disclosure further provides a method of how to determine whether the frequency of the first feature character in the first feature character set is higher than the frequency in the second feature character set. The method is used for determining a distinguishing feature character. It should be noted that other methods may also be used to determine a distinguishing feature character. Specifically, that the frequency of the first feature character in the first feature character set is higher than the frequency in the second feature character set may be represented as: acquiring relative frequencies of the feature characters, the relative frequencies being ratios of the frequencies of the feature characters in the first feature character set to frequencies in the second feature character set; a relative frequency of the first feature character being higher than a predetermined threshold, or rank of a relative frequency of the first feature character in the relative frequencies of all the feature characters being within a set range.

Optionally, this embodiment of the present disclosure further provides a specific implementation manner for verifying the extracted feature characters. It should be noted that separate verification of a single feature character may be used, and after a batch of new feature characters are determined, the batch of the newly determined feature characters may also be used for verification. The following embodiment provides an example of using separate verification, specifically: before the first feature character is added into the malicious feature library, further including: using the first feature character to detect the URLs of the websites determined as the safe websites, and if a false alarm rate is less than a predetermined threshold value, adding the first feature character into the malicious feature library; and using the malicious feature library to detect the URLs of the websites determined as the safe websites, if a false alarm rate is higher than a predetermined threshold value, increasing the predetermined threshold or narrowing the set range, and re-determining whether to add the first feature character into the malicious feature library.

Optionally, when the URL of the website is detected, a feature character matching the malicious feature library is not found, and a page feature may also be used to perform security identification on the website. A person skilled in the art would understand that using a page feature for security identification is only a manner of security identification; many other manners for security identification exist and cannot be listed one by one in this embodiment of the present disclosure. In addition, after the malicious feature library of the URL is used for identification, further executing security identification in other manners may further improve security. In addition, the step may also provide basis for update of the malicious feature library, but further using other manners for security identification is not an absolutely necessary step of this embodiment.

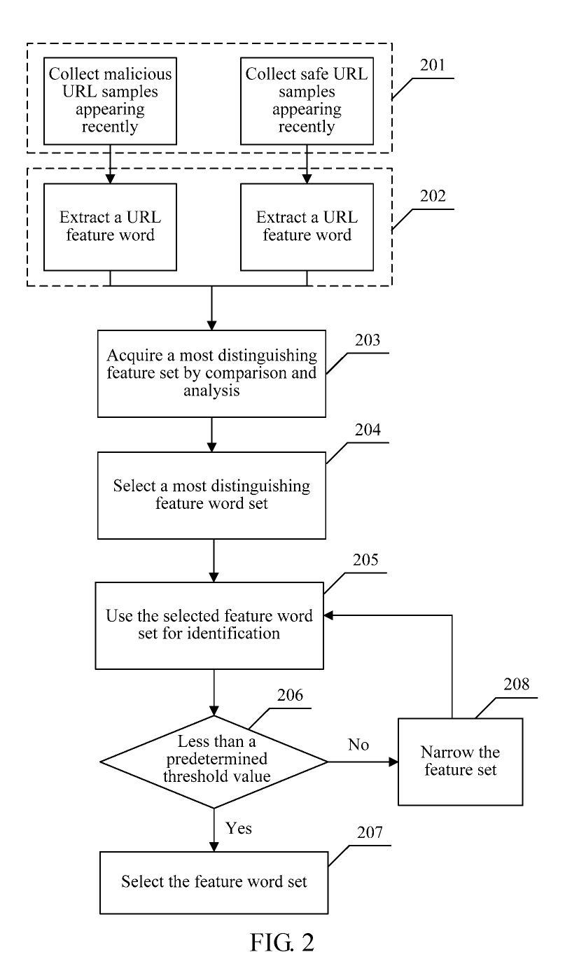

The following embodiment would provide a more detailed example to further describe a method provided by an embodiment of the present disclosure. Referring to FIG. 2, FIG. 2 includes step 201 to step 208.

Step 201: Collect malicious URL samples and safe URL samples appearing recently.

It is assumed that a quantity of the malicious URL samples is N, and a quantity of the safe URL samples are M.

Because a ratio of malicious URLs in an actual network is relatively low (generally being less than 1%), this principle may also be followed in sample selection; for example, it is assumed that a quantity of the malicious URL samples is 10,000, and then 1,000,000 safe URLs may be selected. In addition, during sample selection, it can be avoided that URLs are centralized under a small quantity of domain names; for example, it can be limited that K URLs are selected under each domain name at most.

Step 202: Extract a URL feature word according to a predetermined rule.

This embodiment of the present disclosure does not limit an extraction rule used in this step, and the extraction rule may be adjusted according to actual needs.

For example, a non-number and non-English letter may be selected as a separator to extract the feature word; as regards the following exemplary URL:

http://www.test.com:8080/index.php?id=123#anchor

a feature word set obtained by extraction is {http, www, test, com, 8080, index, php, id, 123, anchor}.

Step 203: Separately collect statistics of a quantity of times of occurrence of feature words in the malicious URLs and safe URLs and obtain by comparison a relative frequency f of each feature word.

As regards word w, a calculation formula of relative frequency f(w) thereof is:

f(w)=(N(w)/N)/(M(w)/M) when M(w)>0;

f(w)=(N(w)/N)/(1/M) , when M(w)=0.

N(w) is a quantity of times of occurrence of w in the malicious URL sample, and N(w)/N is a probability of occurrence of w in the malicious URL sample; M(w) is a quantity of times of occurrence of w in the safe URL sample, and M(w)/M is a probability of occurrence of w in the safe URL sample; a probability of occurrence of a relative frequency representative word in the malicious URL is times of a probability of occurrence in the safe URL. It can be understood that a greater relative frequency indicates that the word is more distinguishing to the malicious URL and the safe URL.

It is assumed that as regards word “http”, N-100, N(“http”)=95, M=10000, M(“http”)=9500,

and then f(“http”)=(95/100)/(9500/10000)=1.

It indicates that as regards “http”, the probabilities of occurrence in the secure and malicious URLs are the same and are not distinguishing.

It is assumed that as regards word “8080”, N=100, N(“8080”)=10, M=10000, M(8080)=50,

and then f(“8080”)=(10/100)/(50/10000)=20.

It indicates that as regards “8080”, a probability of occurrence in the malicious URL is 20 times of a probability of occurrence in the safe URL, and the probabilities are strongly distinguishing.

Step 204: Rank the feature words in a descending manner of relative frequencies and select a most distinguishing feature word set.

For example, feature words of which relative frequencies are ranked top n may be selected; alternatively, a relative frequency threshold value F is set, and only feature words exceeding the threshold value are selected.

Step 205: Use the selected feature word set for identification.

This step is: after the feature word set is selected, when a URL of a website to be detected contains a feature word, the URL may be judged to be a malicious URL.

In addition, step 206 may be further included after step 205.

Step 206: Test a false alarm rate when the feature word set is used, determine whether the false alarm rate is less than a predetermined threshold value, if yes, go to step 207, and if not, go to step 208.

Step 206 may include: selecting a batch of sate URL samples (it is assumed to be n1 URL samples in total) and using the feature word set for detection, where it is assumed that total n2 URL samples are judged to be malicious, and then the false alarm rate is n2/n1.

Step 207: Determine that the feature word set may be selected when the false alarm rate is less than the predetermined threshold value.

Step 208: Narrow the feature set and return to step 204.

Manners for narrowing the feature set may include: reducing a threshold value n (or increasing a threshold value F) to narrow the feature word set. Steps 204, 205, 206, and 208 are circularly performed until a false alarm rate test is passed and go to step 207.

In the forgoing embodiment of the present disclosure, feature character extraction is performed based on a URL, specific feature characters are determined from extracted feature characters and are added into a malicious feature library so as to identify a malicious website, in this embodiment, by means of a comparison method, new presented malicious features in the URL are extracted and added into the malicious feature library, so as to shorten a period to find the new malicious feature after the malicious feature appears.

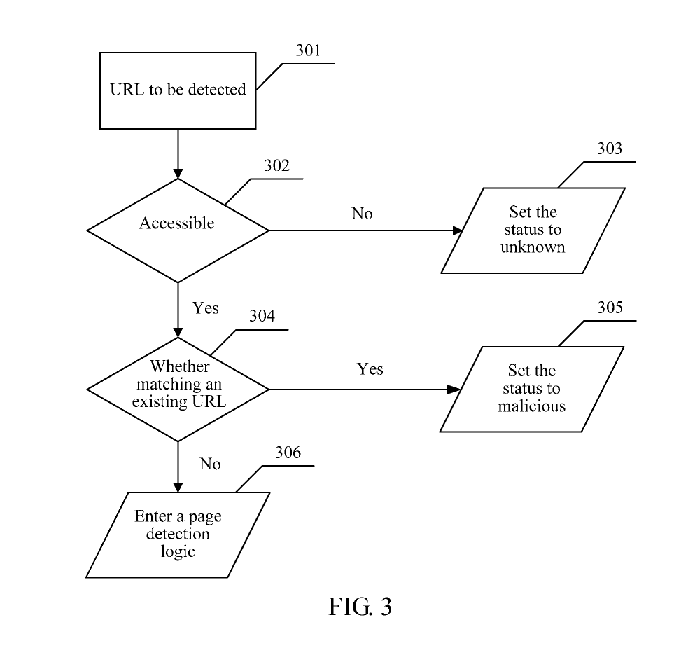

After the feature word is added into the malicious feature library, a method for authenticating a URL of a website is shown in FIG. 3 and may include step 301 to step 306.

Step 301: Acquire a URL to be detected.

Step 302: Detect whether a webpage can be accessed after the URL to be detected is acquired; if the webpage can be accessed, go to step 304; and otherwise, go to step 303.

Step 303: Set a URL status to be unknown if it is determined that the URL to be detected cannot be accessed.

Step 304: Extract a URL feature and match the URL feature and a current malicious feature library if it is determined that the URL to be detected can be accessed, and determine whether matching succeeds (that is, whether an extracted feature character exists in the malicious feature library); if yes, go to step 306; if not, go to step 305.

Step 305: Set a status thereof to be a malicious URL.

Step 306: Enter a page detection logic and further judge and determine, according to a page feature, whether a page corresponding to the URL is malicious.

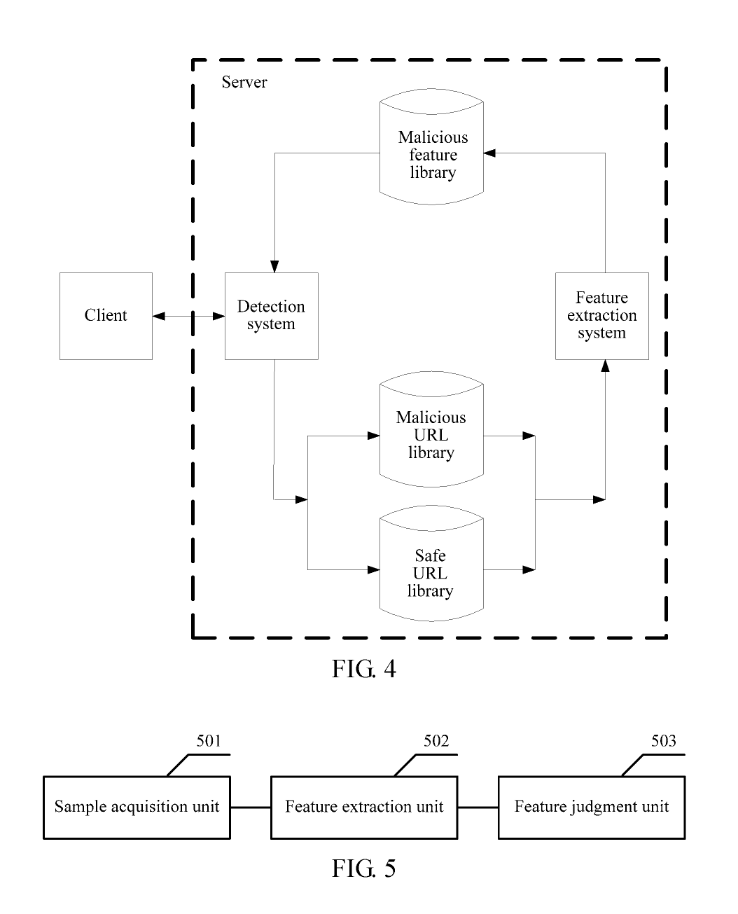

An embodiment of the present disclosure provides a system for identifying a malicious website. A framework of the system is shown in FIG. 4 and includes: a client and a server, where a server side includes: a detection system, a malicious feature library, a feature extraction system, a malicious URL library, and a safe URL library.

The client may be: for example, a terminal device equipped with a client such as an instant messaging and computer management tool.

The whole system framework runs as follows:

The client is configured to send an URL accessed by a user to a detection system of a server;

The detection system is configured to judge the URL sent by the client according to a malicious feature library of a current malicious URL and if a malicious URL feature is not matched, further judge another page feature; malicious URLs identified by the detection system to be malicious and other URLs artificially identified to be malicious are all stored into a malicious URL library, and URLs identified to be secure are stored into a safe URL library; and

A feature extraction system is configured to periodically acquire samples in the malicious URL library and the safe URL library for feature comparison, and find out strongly distinguishing features, so as to continuously supplement and update the current malicious feature library.

In the forgoing embodiment of the present disclosure, feature character extraction is performed based on a URL, specific feature characters are determined from extracted feature characters and are added into a malicious feature library so as to identify a malicious website. In this embodiment, by means of a comparison method, new malicious features in the URL are extracted and added into the malicious feature library, so as to shorten a period to find the new malicious feature after the malicious feature appears.

An embodiment of the present disclosure further provides an apparatus for identifying a malicious website. As shown in FIG. 5, the apparatus includes a sample acquisition unit 501, a feature extraction unit 502, and a feature judgment unit 503.

The sample acquisition unit 501 is configured to acquire URLs of websites determined as malicious websites and URLs of websites determined as safe websites.

In this embodiment, to ensure real-time of a sample set used by a server, the URL of the malicious website may be a URL of a malicious website that is verified within a period before current time; and the URL of the safe website may be a URL of a safe website that is verified within a period before current time. In addition, a quantity of acquired URLs of each domain name is limited within a predetermined quantity; in this way, a problem that domain names are centralized is alleviated. For a background cloud server such as a computer management tool, it would save security information of a great quantity of URLs. Therefore, the sample acquisition unit may obtain relevant URLs from a database of a security server.

The feature extraction unit 502 is configured to perform feature extraction on the URLs, acquired by the sample acquisition unit 501, of the malicious websites to obtain a first feature character set, and perform feature character extraction on the URLs of the safe websites to obtain a second feature character set.

The feature judgment unit 503 is configured to determine whether a frequency of a first feature character obtained by feature extraction unit 502 by feature extraction in the first feature character set is higher than a frequency in the second feature character set, and if the frequency of the first feature character in the first feature character set is higher than the frequency in the second feature character set, add the first feature character into a malicious feature library, feature characters in the malicious feature library being used for identifying feature characters of the malicious website.

In the forgoing embodiment of the present disclosure, feature character extraction is performed based on a URL, specific feature characters are determined from extracted feature characters and are added into a malicious feature library so as to identify a malicious website. In this embodiment, by means of a comparison method, new presented malicious features in the URL are extracted and added into the malicious feature library, so as to shorten a period to find the new malicious feature after the malicious feature appears.

Optionally, this embodiment of the present disclosure further provides a method of how to determine whether the frequency of the first feature character in the first feature character set is higher than the frequency in the second feature character set. The method is used for determining a distinguishing feature character. It should be noted that another method may also be used to determine a distinguishing feature character. Specifically, the feature judgment unit 503 is configured to acquire relative frequencies of the feature characters, the relative frequencies being ratios of the frequencies of the feature characters in the first feature character set to frequencies in the second feature character set.

If a relative frequency of the first feature character is higher than a predetermined threshold, or rank of a relative frequency of the first feature character in the relative frequencies of all the feature characters is within a set range, the first feature character is added into the malicious feature library.

Optionally, this embodiment of the present disclosure further provides a specific implementation manner for verifying the extracted feature characters. It should be noted that separate verification of a single feature character may be used, and after a batch of new feature characters are determined, the batch of the newly determined feature characters may also be used for verification. The following embodiment provides an example of using separate verification, specifically; the feature judgment unit 503 is further configured to, before the first feature character is added into the malicious feature library, use the first feature character to detect the URLs of the websites determined as the safe websites, and if a false alarm rate is less than a predetermined threshold value, add the first feature character into the malicious feature library.

As shown in FIG. 6, the identification apparatus further includes:

a feature library control unit 601, configured to use the malicious feature library to detect the URLs of the websites determined as the safe websites, if a false alarm rate is higher than a predetermined threshold value, increase the predetermined threshold or narrow the set range, and re-determine whether to add the first feature character into the malicious feature library.

Optionally, the feature extraction unit 502 may be configured to perform feature extraction by using a non-number and non-English letter as partition.

It should be noted that feature extraction may be performed in multiple manners; an example in this embodiment is only a preferable example applicable to URL feature extraction and applicable to malicious website identification; an algorithm for changing feature extraction does not influence implementation of this embodiment of the present disclosure; a person skilled in the art may perform algorithm selection according to actual situations. Therefore, this embodiment of the present disclosure does not limit an algorithm used by feature extraction. The foregoing example of performing feature extraction by using a non-number and non-English letter as partition should not be understood as unique limitation to this embodiment of the present disclosure.

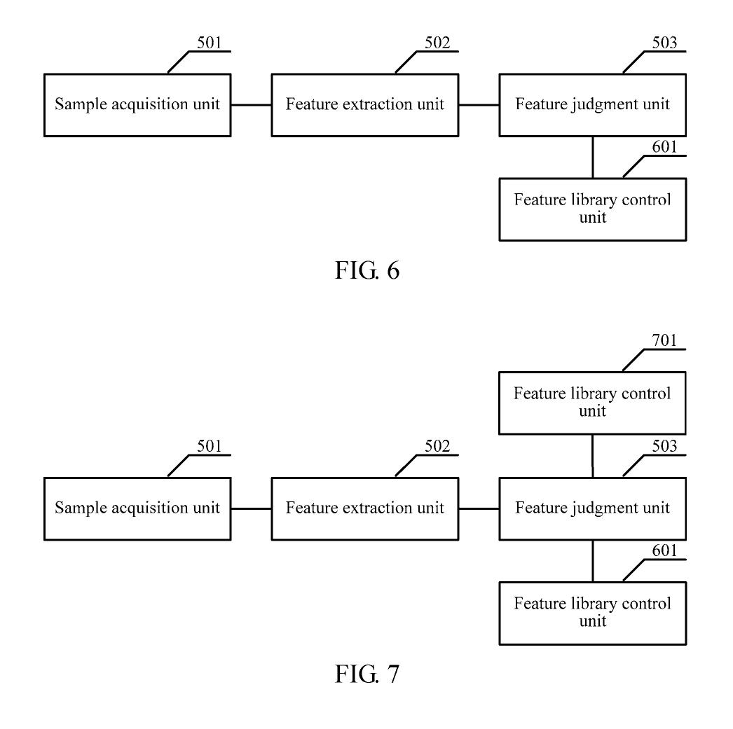

Optionally, when the URL of the website is detected, a feature character matching the malicious feature library is not found, and a page feature may also be used to perform security identification on the website. A person skilled in the art would understand that using a page feature for security identification is only a manner of security identification; many other manners for security identification exist and cannot be listed one by one in this embodiment of the present disclosure. In addition, after the malicious feature library of the URL is used for identification, further executing security identification in other manners may further improve security. In addition, the step may also provide basis for update of the malicious feature library, but further using other manners for security identification is not an absolutely necessary step of this embodiment. As shown in FIG. 7 the identification apparatus further includes:

a page identification unit 701, configured to, if the malicious feature library is used to identify a URL to be identified, an identification result is secure, and the URL to be identified is accessible, use a page feature to perform security identification.

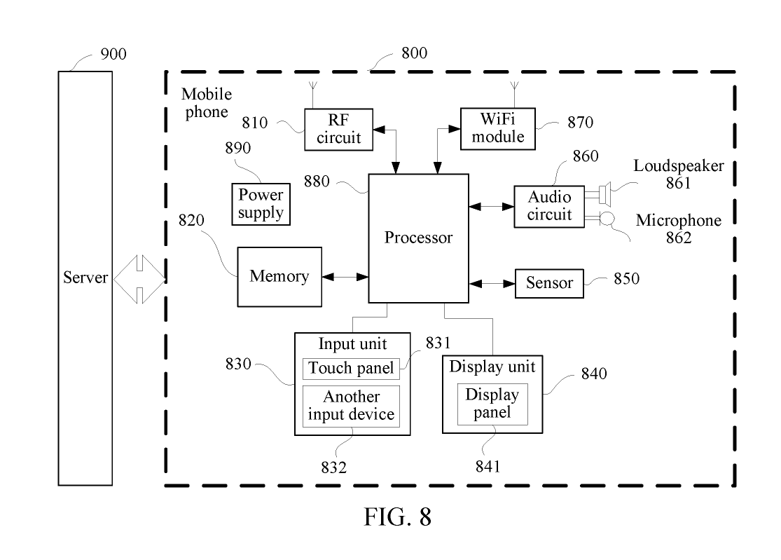

An embodiment of the present disclosure further provides another apparatus for identifying a malicious website. As shown in FIG. 8, to facilitate description, FIG. 8 only shows a part relevant to this embodiment of the present disclosure, and specific technical details are not disclosed. Refer to a method part of this embodiment of the present disclosure. The identification apparatus may include any terminal device such as a mobile phone, a tablet computer, a personal digital assistant (Personal Digital Assistant, PDA), a point of sales (Point of Sales, POS), and an on-board computer. In this embodiment, an example that the identification apparatus is a mobile phone is provided.

FIG. 8 also shows a server 900; it can be understood that the server 900 is not a part of the identification apparatus.

FIG. 8 is a block diagram of a part of a structure of a mobile phone relevant to a terminal according to an embodiment of the present disclosure. Referring to FIG. 8, the mobile phone includes: components such as a radio frequency (Radio Frequency, RF) circuit 810, a memory 820, an input unit 830, a display unit 840, a sensor 850, an audio circuit 860, a wireless fidelity (wireless fidelity, WiFi) module 870, a processor 880, and a power source 890. A person skilled in the art would understand that the mobile phone structure shown in FIG. 8 does not impose a limitation to the mobile phone and may include components more or less than shown ones, or a combination of some components, or different component arrangements.

Constituent components of the mobile phone are specifically introduced with reference to FIG. 8:

The RF circuit 810 may be configured to receive and send a signal in an information receiving and sending or a call process, and in particular, receive downlink information of a base station for the processor 880 to process; in addition, data designed to be uplink is sent to the base station. Generally, the RF circuit includes, but is not limited to, an antenna, at least one amplifier, a transceiver, a coupler, a low noise amplifier (Low Noise Amplifier, LNA), a duplexer, etc. In addition, the RF circuit 80 may communicate with a network and other devices by using wireless communications. The foregoing wireless communication may use any communications standard or protocol, which includes, but is not limited to, global system of mobile communication (Global System of Mobile Communication, GSM), general packet radio service (General Packet Radio Service, GPRS), code division multiple access (Code Division Multiple Access, CDMA), wideband code division multiple access (Wideband Code Division Multiple Access, WCDMA), a long term evolution (Long Term Evolution, LTE), emails, short messaging service (Short Messaging Service, SMS), and the like.

The memory 820 may be configured to store a software program and modules; the processor 880 executes various functional applications of the mobile phone and data processing by running the software program and modules stored in the memory 820. The memory 820 may mainly include a program storage area and a data storage area, where the program storage area may store an operating system, an application program (such as a voice playing function and an image playing function) required by at least one function, and the like; the data storage area may store data (such as audio data and a telephone book) created according to using of the mobile phone and the like. In addition, the memory 820 may include a high random access memory and may further include a nonvolatile memory, for example, at least one magnetic disk storage device, a flash memory device, or other volatile solid storage devices.

The input unit 830 may be configured to receive input number or character information and generate key signal input relevant to user settings and functional control of the mobile phone 800. Specifically, the input unit 830 may include a touch panel 831 and another input device 832. The touch panel 831, also called a touch screen, may collect a touch operation that is performed by a user on or near the touch panel 831 (for example, an operation that is performed by a user on the touch panel 831 or near the touch panel 831 by using any appropriate object, such as a finger and a stylus, or an accessory and drive a corresponding connection apparatus according to a preset program. Optionally, the touch panel 831 may include two parts: a touch detection apparatus and touch controller. The touch detection apparatus detects a touch orientation of a user, detects a signal brought by the touch operation, and transmits the signal to the touch controller; the touch controller receives touch information from the touch detection apparatus and converts the touch information into a contact coordinate, then sends the contact coordinate to the processor 880, and can receive a command sent by the processor 880 and execute the command. In addition, the touch panel 831 may be implemented by using multiple types such as a resistance type, a capacitance type, infrared rays, and surface acoustic waves. In addition to the touch panel 831, the input unit 830 may further include the another input device 832. Specifically, the another input device 832 may include, but is not limited to, one or more of a physical keyword, a function key (such as a volume control key and a switch key), a trackball, a mouse, and an operating rod.

The display unit 840 may be configured to display information input by a user or information provided to a user and various menus of the mobile phone. The display unit 840 may include a display panel 841; optionally, the display panel 841 may be configured by using forms such as a liquid crystal display (Liquid Crystal Display, LCD) and an organic light-emitting diode (Organic Light-Emitting Diode, OLED). Further, the touch panel 831 may cover the display panel 841; when the touch. panel 831 detects the touch operation performed on or near the touch panel 831, the touch operation is transmitted to the processor 880 to determine a type of an touch event, and then the processor 880 provides corresponding visual output on the display panel 841 according to the type of the touch event. Although in FIG. 8, the touch panel 831 and the display panel 841 implement input and output functions of the mobile phone as two independent components; however, in some embodiments, the touch panel 831 may be integrated with the display panel 841. to implement the input and output functions of the mobile phone.

The mobile phone 800 may further include at least one sensor 850, such as an optical sensor, a motion sensor, and other sensors. Specifically, the optical sensor may include an environment optical sensor and a proximity sensor, where the environment optical sensor may adjust luminance of the display panel 841 according to brightness of environment light, and the proximity sensor may close the display panel 841 and/or backlight when the mobile phone moves to an ear. As a motion sensor, an accelerometer sensor may detect accelerations in various directions (generally three axes), may detect the magnitude and direction of gravity in a static state, may be configured to identify an application of mobile phone posture (such as landscape/portrait mode switching, relevant games, and magnetometer posture calibration), a vibration identification relevant function (such as a pedometer and knocking), and the like; other sensors, such as a gyroscope, a barometer, a hygrometer, a thermometer, and an infrared sensor, which may be configured by the mobile phone are not described in detail herein.

The audio circuit 860, a loudspeaker 861 and a microphone 862 may provide an audio interface between a user and the mobile phone. The audio circuit 860 may transmit an electric signal into which received audio data is converted to the loudspeaker 861, and the loudspeaker 861 converts the electric signal into a sound signal for output; on the other hand, the loudspeaker 862 converts the collected sound signal into an electric signal, the audio circuit 860 receives the electric signal and converts the electric signal into audio data, then the audio data is output to the processor 880 for processing, and the audio data passes through the RF circuit 810 to be sent to, for example, another mobile phone, or is output to the memory 820 fix further processing.

In addition, the mobile phone may help a user to receive and send e-mails, browse webpages, access streaming media, and the like by using a wireless communications module, for example, the WiFi module 870 shown in FIG. 8, the wireless communications module provides wireless broadband Internet access for a user. Although FIG. 8 shows the WiFi module 870, it can be understood that the WiFi module 870 is not a necessary composition of the mobile phone 800 and can be omitted completely according to needs within a range in which the nature of the present disclosure is not changed.

The processor 880 is a control center of the mobile phone, uses various interfaces and lines to connect various parts of the whole mobile phone, executes various functions of the mobile phone and processes data by running or executing the software program and/or modules stored in the memory 820 and calling data stored in the memory 820, so as to perform whole monitoring of the mobile phone. Optionally, the processor 880 may include one or more processing units; preferably, the processor 880 may integrate an application processor and a modulation and demodulation processor, where the application processor mainly processes an operating system, a user interface, an application program, and the like, and the modulation and demodulation processor mainly processes wireless communications. It can be understood that the modulation and demodulation processor may also not be integrated in the processor 880.

The mobile phone 800 further includes the power source 890 (such as a battery) supplying power to components; preferably, the power source may be logically connected to the processor 880 by using a power source management system, so as to implement functions of charging and discharging management and power consumption management by using the power source management system.

Although not shown, the mobile phone 800 may further include a camera, a Bluetooth module, and the like, which is not described in detail herein.

In this embodiment of the present disclosure, the processor 880 included in the terminal further has the following functions:

The processor 880 is configured to receive input of a user by using the input unit 830 so as to acquire a URL as a URL to be identified, send the URL to be identified to the server 900 by using a transmission device, such as the RF circuit 810 or the WiFi module 870, and receive an identification result returned by the server 900 by using the RF circuit 810 or the WM module 870 The identification result may also be displayed in the display unit 840.

At one side of the server 900, the server 900 is configured to acquire URLs of websites determined as a malicious website and URLs of websites determined as a safe website, perform feature extraction on the URLs of the malicious websites to obtain a first feature character set and perform feature extraction on the URLs of the safe websites to obtain a second feature character set, if a frequency of the first feature character obtained by feature extraction in the first feature character set is higher than a frequency in the second feature character set, adding the first feature character into a malicious feature library, receive a URL to be identified, extract a feature character of the URL to be identified, match the feature character and the malicious feature library, and if the URL to be identified exists in the malicious feature library, determine that the URL is a malicious URL and send a malice prompting message to the mobile phone 800. It can be understood that if the URL is of the safe website, a security prompting message may also be sent to the mobile phone 800.

In this embodiment, to ensure real-time of a sample set used by a server, the URL of the malicious website may be limited as a URL of a malicious website that is verified within a period before current time; and the URL of the safe website may be a URL of a safe website that is verified within a period before current time. In addition, a quantity of acquired URLs of each domain name is limited within a predetermined quantity; in this way, a problem that domain names are centralized is alleviated. For a background cloud server such as a computer management tool, it would save security information of a great quantity of URLs. Therefore, the server 900 may obtain a relevant URL from a database of a security server.

Optionally, the server 900 may be configured to perform feature extraction, for example, performing feature extraction by using a non-number and non-English letter as partition.

It should be noted that feature extraction may be performed in multiple manners; an example in this embodiment is only a preferable example applicable to URL feature extraction and applicable to malicious website identification; an algorithm for changing feature extraction does not influence implementation of this embodiment of the present disclosure; a person skilled in the art may perform algorithm selection according to actual situations. Therefore, this embodiment of the present disclosure does not limit an algorithm used by feature extraction. The foregoing example of performing feature extraction by using a non-number and non-English letter as partition should not be understood as unique limitation to this embodiment of the present disclosure.

Optionally, this embodiment of the present disclosure further provides a method of how to determine whether the frequency of the first feature character in the first feature character set is higher than the frequency in the second feature character set. The method is used for determining a distinguishing feature character. It should be noted that another method may also be used to determine a distinguishing feature character. Specifically, the server 900 may be configured to acquire relative frequencies of feature characters, the relative frequencies being ratios of frequencies of the feature characters in the first feature character set to frequencies in the second feature character set, and if a relative frequency of the first feature character is higher than a predetermined threshold, or rank of a relative frequency of the first feature character in the relative frequencies of all the feature characters is within a set range, add the first feature character into the malicious feature library.

Optionally, this embodiment of the present disclosure further provides a specific implementation manner for verifying the extracted feature characters, It should be noted that separate verification of a single feature character may be used, and after a batch of new feature characters are determined, the batch of the newly determined feature characters may also be used for verification. The following embodiment provides an example of using separate verification, specifically: the server 900 may be further configured to, before the first feature character is added into the malicious feature library, use the first feature character to detect the URLs of the websites determined as the safe websites, and if a false alarm rate is less than a predetermined threshold value, add the first feature character into the malicious feature library.

Optionally, the server 900 may be further configured to use the malicious feature library to detect the URLs of the websites determined as the safe websites, if a false alarm rate is higher than a predetermined threshold value, increase the predetermined threshold or narrow the set range, and re-determine whether to add the first feature character into the malicious feature library.

Optionally, when the URL of the website is detected, a feature character matching the malicious feature library is not found, and a page feature may also be used to perform security identification on the website. A person skilled in the art would understand that using a page feature for security identification is only a manner of security identification; many other manners for security identification exist and cannot be listed one by one in this embodiment of the present disclosure. In addition, after the malicious feature library of the URL is used for identification, further executing security identification in other manners may further improve security. In addition, the step may also provide basis for update of the malicious feature library, but further using other manners for security identification is not an absolutely necessary step of this embodiment. The server 900 may be further configured to, if the malicious feature library is used to identify a URL to be identified, an identification result is secure, and the URL to be identified is accessible, use a page feature to perform security identification.

It should be noted that in the foregoing embodiments of the identification apparatus, included units are only divided according to functional logics but are limited to the division, and are acceptable as long as the units can implement corresponding functions. In addition, specific titles of functional units are only used for distinguishing from each other and are not used for limiting the protection scope of the present disclosure.

In addition, a person of ordinary skill in the art may understand that all or some of the steps of the foregoing method embodiments may be implemented by using a program to instruct relevant hardware, and the corresponding program may be stored in a computer readable storage medium. The storage medium may be a read-only memory, a magnetic disk, an optical disc, or the like.

The foregoing descriptions are merely specific preferable embodiments of the present disclosure, but are not intended to limit the protection scope of the present disclosure. Any variation or replacement readily figured out by a person skilled in the art within the technical scope disclosed in the embodiments of the present disclosure shall fall within the protection scope of the present disclosure. Therefore, the protection scope of the present disclosure shall be subject to the appended claims.

What is claimed is:

1. A method for identifying a malicious website, comprising:
acquiring uniform resource locators (URL) of websites determined as malicious websites and URLs of websites determined as safe websites;
performing feature extraction on the URLs of the malicious websites to obtain a first feature character set, and performing feature character extraction on the URLs of the safe websites to obtain a second feature character set; and
determining whether a frequency of a first feature character obtained by feature extraction in the first feature character set is higher than a frequency in the second feature character set, and if the frequency of the first feature character in the first feature character set is higher than the frequency in the second feature character set, adding the first feature character into a malicious feature library, feature characters in the malicious feature library being used for identifying a malicious website.

2. The method according to claim 1, wherein the determining whether a frequency of a first feature character obtained by extraction in the first feature character set is higher than a frequency in the second feature character set comprises:
acquiring a relative frequency of the first feature character, the relative frequency of the first feature character being a ratio of the frequency of the first feature character in the first feature character set to the frequency in the second feature character set; and
determining whether the relative frequency of the first feature character is higher than a predetermined threshold, or determining whether rank of the relative frequency of the first feature character in relative frequencies of all feature characters is within a set range.

3. The method according to claim 1, before the adding the first feature character into a malicious feature library, further comprising:
using the first feature character to detect the URLs of the websites determined as the safe websites, and if a false alarm rate is less than a predetermined threshold value, adding the first feature character into the malicious feature library.

4. The method according to claim 2, further comprising:
using the malicious feature library to detect the URLs of the websites determined as the safe websites, if a false alarm rate is higher than a predetermined threshold value, increasing the predetermined threshold or narrowing the set range, and re-determining whether to add the first feature character into the malicious feature library.

5. The method according to claim 1, wherein the performing feature extraction comprises:
performing feature extraction by using a non-number and non-English letter as partition.

6. The method according to claim 1, if the malicious feature library is used to identify a URL to be identified, and an identification result is safe, further comprising:
if the URL to be identified is accessible, using a page feature to perform security identification on the URL to be identified.

7. An apparatus for identifying a malicious website, comprising:
a sample acquisition unit, configured to acquire uniform resource locators (URLs) of websites determined as malicious websites and URLs of websites determined as safe websites;
a feature extraction unit, configured to perform feature extraction on the URLs, acquired by the sample acquisition unit, of the malicious websites to obtain a first feature character set and perform feature character extraction on the URLs of the safe websites to obtain a second feature character set; and
a feature judgment unit, configured to determine whether a frequency of a first feature character obtained by feature extraction in the first feature character set is higher than a frequency in the second feature character set, and if the frequency of the first feature character in the first feature character set is higher than the frequency in the second feature character set, add the first feature character into a malicious feature library, feature characters in the malicious feature library being used for identifying a malicious website.

8. The identification apparatus according to claim 7, wherein
the feature judgment unit is configured to acquire a relative frequency of the first feature character, the relative frequency of the first feature character being a ratio of the frequency of the first feature character in the first feature character set to the frequency in the second feature character set; and
determine whether the relative frequency of the first feature character is higher than a predetermined threshold, or determine whether rank of the relative frequency of the first feature character in relative frequencies of all feature characters is within a set range.

9. The identification apparatus according to claim 7, wherein
the feature judgment unit is further configured to, before the first feature character is added into the malicious feature library, use the first feature character to detect the URLs of the websites determined as the safe websites, and if a false alarm rate is less than a predetermined threshold value, add the first feature character into the malicious feature library.

10. The identification apparatus according to claim 8, further comprising:
a feature library control unit, configured to use the malicious feature library to detect the URLs of the websites determined as the safe websites, if a false alarm rate is higher than a predetermined threshold value, increase the predetermined threshold or narrow the set range, and re-determine whether to add the first feature character into the malicious feature library.

11. The identification apparatus according to claim 7, wherein
the feature extraction unit is configured to perform feature extraction by using a non-number and non-English letter as partition.

12. The identification apparatus according to claim 7, further comprising:
a page identification unit, configured to, if the malicious feature library is used to identify a URL to be identified, an identification result is safe, and the URL to be identified is accessible, use a page feature to perform security identification.

13. A non-instantaneous computer readable storage medium, storing computer executable instructions thereon, and when these executable instructions are run in a computer, executing the following steps:
acquiring uniform resource locators (URLs) of websites determined as malicious websites and URLs of websites determined as safe websites;
performing feature extraction on the URLs of the malicious websites to obtain a first feature character set, and performing feature character extraction on the URLs of the safe websites to obtain a second feature character set; and
determining whether a frequency of a first feature character obtained by feature extraction in the first feature character set is higher than a frequency in the second feature character set, and if the frequency of the first feature character in the first feature character set is higher than the frequency in the second feature character set, adding the first feature character into a malicious feature library, feature characters in the malicious feature library being used for identifying a malicious website.

14. The non-instantaneous computer readable storage medium according to claim 13, wherein the step of determining whether a frequency of a first feature character obtained by extraction in the first feature character set is higher than a frequency in the second feature character set comprises:
acquiring a relative frequency of the first feature character, the relative frequency of the first feature character being a ratio of the frequency of the first feature character in the first feature character set to the frequency in the second feature character set; and
determining whether the relative frequency of the first feature character is higher than a predetermined threshold, or determining whether rank of the relative frequency of the first feature character in relative frequencies of all feature characters is within a set range.

15. The non-instantaneous computer readable storage medium according to claim 13, before the adding the first feature character into a malicious feature library, further comprising the following step:
using the first feature character to detect the URLs of the websites determined as the safe websites, and if a false alarm rate is less than a predetermined threshold value, adding the first feature character into the malicious feature library.

16. The non-instantaneous computer readable storage medium according to claim 14, further comprising the following step:
using the malicious feature library to detect the URLs of the websites determined as the safe websites, if a false alarm rate is higher than a predetermined threshold value, increasing the predetermined threshold or narrowing the set range, and re-determining whether to add the first feature character into the malicious feature library.

17. The non-instantaneous computer readable storage medium according to claim 13, wherein the step of performing feature extraction comprises:
performing feature extraction by using a non-number and non-English letter as partition.

18. The non-instantaneous computer readable storage medium according to claim 13, if the malicious feature library is used to identify a URL to be identified, and an identification result is safe, further comprising the following step:
if the URL to be identified is accessible, using a page feature to perform security identification on the URL to be identified.
